(19) United States
(12) Patent Application Publication
(10) Pub. No.: US 2015/0343844 A1
(43) Pub. Date: Dec. 3, 2015

(54) Pneumatic Tire

(71) Applicant: THE YOKOHAMA RUBBER CO., LTD., Minato-ku, Tokyo (JP)

(72) Inventor: Hideki Seto, Hiratsuka-shi, Kanagawa (JP)

(21) Appl. No.: 14/649,190

(22) PCT Filed: Nov. 29, 2013
(86) PCT No.: PCT/JP2013/082254

§ 371 Date: Jun. 2, 2015

(30) Foreign Application Priority Data
Dec. 3, 2012 (JP) 2012-264246

(51) Int. Cl. B60C 5/14; B60C 1/00

(52) U.S. Cl. CPC B60C 5/14; B60C 1/0008; B60C 2005/147

(57) ABSTRACT

A pneumatic tire includes an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition. The sheet obtained from the thermoplastic resin or the thermoplastic resin composition of a thermoplastic resin blended with an elastomer that is employed has a plurality of notches having a notch width greater than 1.0 mm provided in a leading edge portion or a vicinity of the leading edge portion of at least one side of the sheet.

### TECHNICAL FIELD

The present technology relates to a pneumatic tire.

More particularly, the present technology relates to a pneumatic tire having an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, wherein the pneumatic tire has excellent durability without the generation of cracks and/or separation of the sheet obtained from the thermoplastic resin or the thermoplastic resin composition of a thermoplastic resin blended with an elastomer in the vicinity of the overlap splice portion after the pneumatic tire begins traveling.

### BACKGROUND

Recently, the use of a sheet-like pneumatic tire inner liner obtained from a thermoplastic resin or a thermoplastic resin composition of a thermoplastic resin blended with an elastomer, has been proposed and studied (see, e.g., Japanese Unexamined Patent Application Publication No. 2009-241855A).

When actually using this sheet-like object obtained from the thermoplastic resin or the thermoplastic resin composition of a thermoplastic resin blended with an elastomer in a pneumatic tire inner liner, normally a manufacturing technique of winding a laminate sheet of the sheet obtained from the thermoplastic resin or the thermoplastic resin composition of a thermoplastic resin blended with an elastomer and a rubber (tie rubber) sheet that undergoes vulcanizing adhesion to the sheet obtained from the thermoplastic resin or the thermoplastic resin composition of a thermoplastic resin blended with an elastomer onto a tire molding drum, performing a lap splice, and then supplying to the tire vulcanization molding process is used.

However, when a tire is manufactured by winding the abovementioned laminate sheet of a thermoplastic resin or a thermoplastic resin composition of a thermoplastic resin blended with an elastomer and the tie rubber layer into a roll, pulling and cutting the laminate sheet from this roll into portions of a required length, then winding the cut lengths onto a tire molding drum for lap splicing and then performing vulcanization molding, separation may occur between the sheet obtained from the thermoplastic resin or the thermoplastic resin composition that constitutes the inner liner and the tie rubber sheet for vulcanizing adhesion with the sheet obtained from the thermoplastic resin or the thermoplastic resin composition after the tire has started traveling.

When explained with reference to a drawing as illustrated in FIG. 5A, a laminate sheet 1, in which a sheet 2 obtained from a thermoplastic resin or a thermoplastic resin composition of a thermoplastic resin blended with an elastomer is laminated with a tie rubber layer 3, is cut into certain sizes (lengths) with a blade or the like and then spliced on a tire molding drum so that a ring-like overlap splice portion S is formed at both end portions of the laminate sheet 1. When one laminate sheet 1 is used, both end portions are spliced so that a ring shape is formed, and when a plurality of the laminate sheets 1 are used, the mutual end portions of each of the laminate sheets 1 are spliced together so that a ring shape is formed.

Next, other parts (not illustrated) required for tire manufacturing are wound and the tire undergoes vulcanization molding using a bladder. After the vulcanization molding, an inner liner layer 10 is formed including the tie rubber layer 3 and the sheet 2 obtained from the thermoplastic resin or the thermoplastic resin composition of a thermoplastic resin blended with an elastomer, and an exposed portion and a portion embedded in the tie rubber layer of the sheet 2 obtained from the thermoplastic resin or the thermoplastic resin composition are formed in the vicinity of the overlap splice portion S, as illustrated in FIG. 5B.

Specifically, the sheet 2 obtained from the thermoplastic resin or the thermoplastic resin composition of a thermoplastic resin blended with an elastomer is present in two layers above and below an interposed tie rubber layer 3′ in the vicinity of the overlap splice portion S. Note that a green tire is produced such that the sheet 2 obtained from the thermoplastic resin composition is arranged on the tire cavity side thereof, wherein the upper side in FIGS. 5A and 5B is the tire cavity side.

The phenomenon of the sheet 2 obtained from the thermoplastic resin or the thermoplastic resin composition and the vulcanizing-adhered tie rubber sheet 3 separating after the start of use of the tire occurs where the sheet 2 obtained from the thermoplastic resin or the thermoplastic resin composition shown in FIG. 5B in particular is exposed and at a vicinity of a leading edge portion 4, and the phenomenon first involves a crack being produced and the crack further advancing so that the phenomenon of separation of the sheet proceeds.

The cause of this is interpreted to be that the sheet 2 obtained from the thermoplastic resin or the thermoplastic resin composition generally has a higher modulus in the low-extension region than a rubber compound does, and in particular, the rigidity of the splice portion becomes higher than that of other portions due to two layers being present sandwiching the tie rubber sheet in the vicinity of the splice portion S as described above, and due to this difference in rigidity, stress is concentrated in the vicinity of the splice portion, and shearing strain occurring within the plane of the sheet 2 obtained from the thermoplastic resin or the thermoplastic resin composition causes generation of cracks and/or separation as well as failure or the like.

### SUMMARY

The present technology provides a pneumatic tire having an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, wherein the pneumatic tire has excellent durability without the generation of cracks and/or separation of the sheet obtained from a thermoplastic resin or a thermoplastic resin composition of a thermoplastic resin blended with an elastomer in the vicinity of the overlap splice portion after the pneumatic tire begins traveling.

A pneumatic tire of the present technology has the configuration (1) below.

(1) A pneumatic tire having an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, wherein the sheet obtained from the thermoplastic resin or the thermoplastic resin composition of a thermoplastic resin blended with an elastomer that is employed has a plurality of notches having a notch width greater than 1.0 mm provided in a leading edge portion or a vicinity of the leading edge portion of at least one side of the sheet.

Furthermore, the pneumatic tire of the present technology preferably has any of the following configurations (2) to (10).

(2) The pneumatic tire according to (1) above, wherein a total of widths of non-notch portions of a sheet end portion, in which the notches are provided, of the sheet obtained from the thermoplastic resin or the thermoplastic resin composition of a thermoplastic resin blended with an elastomer is from 20% to 50% of a total width of the sheet.

(3) The pneumatic tire according to (1) or (2) above, wherein the notches are provided having a notch pitch of not less than 2 mm and not greater than 30 mm.

(4) The pneumatic tire according to any one of (1) to (3) above, wherein the length of the notches, as the length of the tire circumferential direction component thereof, is not less than 0.2 times and not greater than 1.5 times the overlap length of the overlap splice portion.

(5) The pneumatic tire according to (4) above, wherein the length of the notches, as the length of the tire circumferential direction component thereof, is not less than 0.4 times and not greater than 1.0 times the overlap length of the overlap splice portion.

(6) The pneumatic tire according to any one of (1) to (5) above, wherein the notches are provided having a notch angle of from 30° to 90° relative to a leading edge portion line direction of the sheet obtained from the thermoplastic resin or the thermoplastic resin composition of a thermoplastic resin blended with an elastomer.

(7) The pneumatic tire according to any one of (1) to (6) above, wherein the width of the notches is not greater than 80% of the notch pitch.

(8) The pneumatic tire according to any one of (1) to (7) above, wherein the notches are provided in the sheet obtained from the thermoplastic resin or the thermoplastic resin composition of a thermoplastic resin blended with an elastomer arranged on a tire cavity side in the overlap splice portion.

(9) The pneumatic tire according to any one of (1) to (8) above, wherein the leading edge portion of the sheet obtained from the thermoplastic resin or the thermoplastic resin composition of a thermoplastic resin blended with an elastomer in the overlap splice portion has been sharpened.

(10) The pneumatic tire according to (9) above, wherein the sharpening has a relationship in which a thickness T (μm) at a position at a distance inward by a length of t×⅓ from the leading edge of the sheet obtained from the thermoplastic resin or the thermoplastic resin composition of a thermoplastic resin blended with an elastomer satisfies the equation 0.1 t≦T≦0.8 t.

Here, t is the average thickness (μm) in the tire circumferential direction of a portion not subject to sharpening of the sheet obtained from the thermoplastic resin or the thermoplastic resin composition of a thermoplastic resin blended with an elastomer, and T is the thickness (μm) of the sheet 2 at a position at a distance inward by a length of t×⅓ from the leading edge of the sheet obtained from the thermoplastic resin or the thermoplastic resin composition of a thermoplastic resin blended with an elastomer.

(11) The pneumatic tire according to any one of (1) to (10) above, wherein both side wall portions of the notches have been sharpened.

(12) The pneumatic tire according to (11) above, wherein the sharpening of both side wall portions of the notches has a relationship in which a thickness T (μm) at a position at a distance inward by a length of t×⅓ in a direction perpendicular to the notch side walls from the leading edge of the notch side walls of the sheet obtained from the thermoplastic resin or the thermoplastic resin composition of a thermoplastic resin blended with an elastomer satisfies the equation 0.1 t≦T≦0.8 t.

Here, t is the average thickness (μm) in the tire circumferential direction of a portion not subject to sharpening of the sheet obtained from the thermoplastic resin or the thermoplastic resin composition of a thermoplastic resin blended with an elastomer,

and T is the thickness (μm) of the sheet 2 at a position at a distance inward by a length of t×⅓ in a direction perpendicular to the notch side walls from the leading edge of the sheet obtained from the thermoplastic resin or the thermoplastic resin composition of a thermoplastic resin blended with an elastomer.

The pneumatic tire of the present technology according to claim 1 provides a pneumatic tire having an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, wherein the pneumatic tire has excellent durability and suppresses the generation of cracks and/or separation of the sheet obtained from the thermoplastic resin or the thermoplastic resin composition of a thermoplastic resin blended with an elastomer in the vicinity of the overlap splice portion, in which an inner liner layer or a reinforcing sheet has been overlap spliced, after the pneumatic tire begins traveling.

In particular, according to the pneumatic tire of the present technology according to any of claims 2 to 12, it is possible to obtain the effect of the pneumatic tire of the present technology according to claim 1, and further, to obtain the effect more reliably and to a greater extent.

### BRIEF DESCRIPTION OF THE DRAWINGS

FIGS. 1A to 1C are schematic views of main parts illustrating embodiments of the pneumatic tire of the present technology, wherein FIG. 1A is a plan view in the vicinity of an overlap splice portion S, FIG. 1B is a section view in the vicinity of the overlap splice portion S, and FIG. 1C is a section view in the vicinity of the overlap splice portion S illustrating another embodiment of the pneumatic tire of the present technology.

FIGS. 2A and 2B are schematic views of main parts illustrating an embodiment of the pneumatic tire of the present technology, and are plan views of the vicinity of an overlap splice portion S of a sheet 2 obtained from a thermoplastic resin or a thermoplastic resin composition.

FIGS. 3A to 3C are schematic views of main parts illustrating an embodiment of the pneumatic tire of the present technology, and are plan views of the vicinity of an overlap splice portion S.

FIGS. 4A to 4D are schematic views of main parts illustrating an embodiment of the pneumatic tire of the present technology, and are explanatory views of a sharpened portion of a sheet 2 in the vicinity of an overlap splice portion S.

FIGS. 5A to 5B explain problems of conventional art, wherein FIG. 5A is a model for illustrating a state in which a laminate sheet 1 having a prescribed length, in which a sheet 2 obtained from a thermoplastic resin or a thermoplastic resin composition is laminated with rubber 3 that undergoes vulcanizing adhesion with the thermoplastic resin or the thermoplastic resin composition, has been wound onto a tire molding drum, and both end portions of the laminate sheet 1 have been lap-spliced. FIG. 5B is a model for illustrating the state illustrated in FIG. 5A after vulcanization molding.

FIG. 6 is a partially fragmented perspective view illustrating an example of an embodiment of the pneumatic tire according to the present technology.

### DETAILED DESCRIPTION

A detailed explanation of the pneumatic tire of the present technology will be given below.

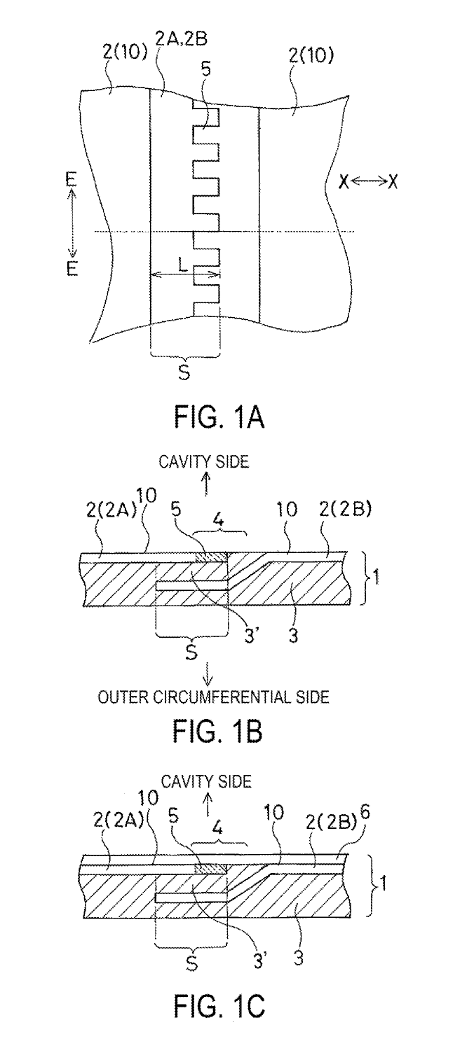

The pneumatic tire of the present technology, as illustrated in FIG. 1, is a pneumatic tire having an overlap splice portion S formed by laminating a sheet 2 obtained from a thermoplastic resin or a thermoplastic resin composition of a thermoplastic resin blended with an elastomer above and below an interposed rubber layer 3′ that undergoes vulcanizing adhesion with the thermoplastic resin or the thermoplastic resin composition, wherein the sheet 2 obtained from the thermoplastic resin or the thermoplastic resin composition of a thermoplastic resin blended with an elastomer that is employed has a plurality of notches 5 having a notch width greater than 1.0 mm provided in a leading edge portion or a vicinity of the leading edge portion of at least one side of the sheet 2.

In the present technology, the sheet 2 obtained from the thermoplastic resin or the thermoplastic resin composition of a thermoplastic resin blended with an elastomer constitutes, in a pneumatic tire, an inner liner layer (air penetration preventing layer) or a reinforcing sheet for reinforcing certain portions of the tire.

The sheet 2 is present in the pneumatic tire employed as a laminate sheet 1 laminated with rubber such as tie rubber 3, and in the present technology, an overlap splice portion S is configured, the overlap splice portion S having a structure in which end portions of the laminate sheet are overlapped, and is disposed inside the pneumatic tire, forming the inner liner or reinforcing sheet.

In the pneumatic tire of the present technology, as illustrated in FIGS. 1A and 1B, the sheet 2 obtained from the thermoplastic resin or the thermoplastic resin composition of a thermoplastic resin blended with an elastomer that is employed has a plurality of notches 5 having a notch width greater than 1.0 mm provided in a leading edge portion or a vicinity of the leading edge portion of at least one side of the sheet 2.

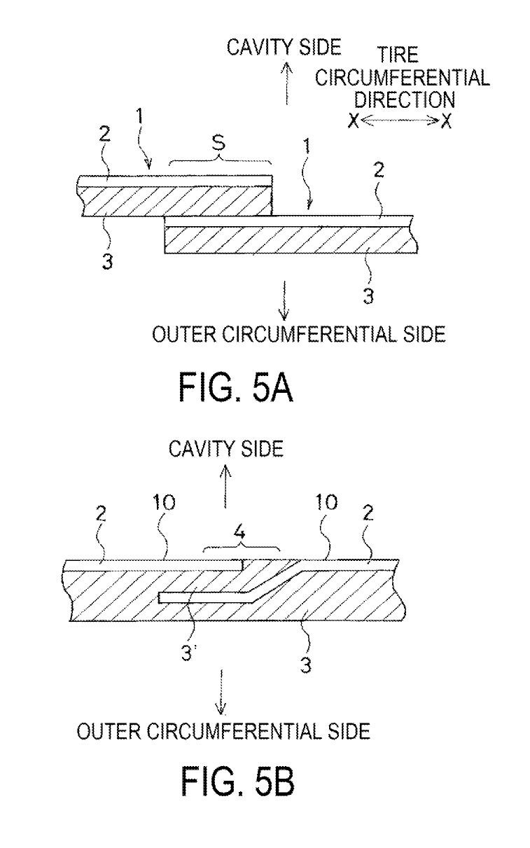

Due to being constructed in this manner, in the pneumatic tire of the present technology, shearing strain can be alleviated and the generation of cracks can be suppressed as a whole because even if a crack is generated along the splice portion, it does not grow and develop into a major crack because the cracks are separated and do not connect to each other, due to the fact that a rubber layer 3′ (tie rubber 3) is present between the upper and lower sheets 2 that are overlap spliced, and the fact that a plurality of notches 5 having a notch width greater than 1.0 mm are provided in a leading edge portion or a vicinity of the leading edge portion of at least one side of the top and bottom sheets 2 obtained from a thermoplastic resin or a thermoplastic resin composition of a thermoplastic resin blended with an elastomer, whereas, in the conventional configuration illustrated in FIG. 5, cracks and/or separation occur due to shearing strain within the plane of the sheet 2 obtained from a thermoplastic resin or a thermoplastic resin composition of a thermoplastic resin blended with an elastomer. If the notch width is less than 1.0 mm, the effect of the present technology is limited because the effect of separating and not connecting cracks to each other is small. In FIG. 1, the E-E direction is the tire width direction.

The pneumatic tire of the present technology may also have an adhesive rubber layer 6 in the innermost layer on the cavity side, as illustrated in FIG. 1C. By providing the adhesive rubber layer 6, it is possible to more effectively suppress generation of cracks and/or separation in the overlap splice portion S. The adhesive rubber layer 6 may be provided along the overlap splice portion S in the vicinity thereof, or it may be provided on the entire inner circumferential surface of the tire cavity.

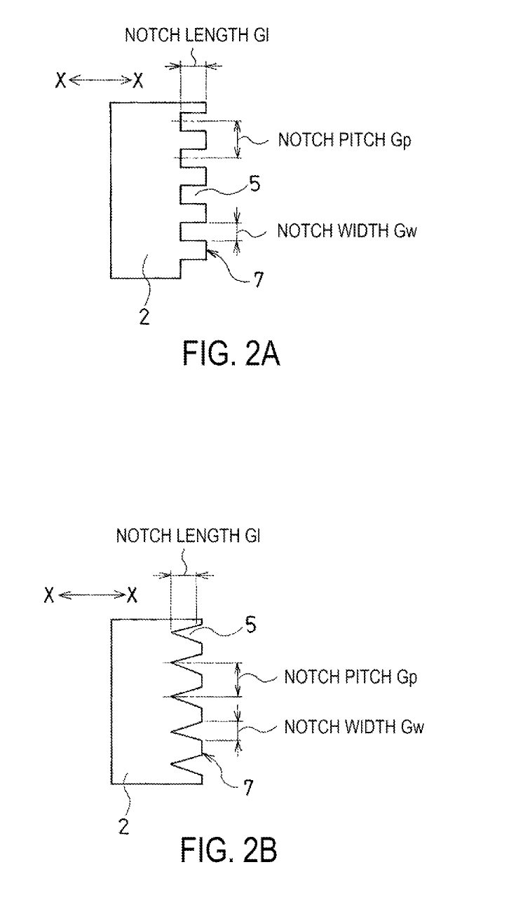

The notches 5 preferably have a rectangular shape as illustrated in FIG. 2A or a triangular shape as illustrated in FIG. 2B.

Furthermore, in the pneumatic tire of the present technology, preferably, the total of widths of non-notch portions of the sheet end portion of the sheet 2 obtained from the thermoplastic resin or the thermoplastic resin composition of a thermoplastic resin blended with an elastomer in which the notches 5 are provided is from 20% to 50% of the total width of the sheet. This is because if the notches are present continuously, it is not desirable because they become the origin points of crack generation, and it is preferred that a flat linear portion is present to an appropriate degree (from 20% to 50% of total width) as the leading edge line 7 of the sheet 2. More preferably, it is from 30% to 50%.

As illustrated in FIGS. 2A and 2B, the notches 5 having a notch pitch Gp of not less than 2 mm and not greater than 30 mm is preferred from the perspective that the effect of providing the notches is greatly exhibited. The notch length Gl, as the length of the tire circumferential direction component thereof, is preferably not less than 0.2 times and not greater than 1.5 times the overlap length L of the overlap splice portion (FIG. 1A). More preferably, the notch length Gl, as the length of the tire circumferential direction component thereof, is not less than 0.4 times and not greater than 1.0 times the overlap length L of the overlap splice portion.

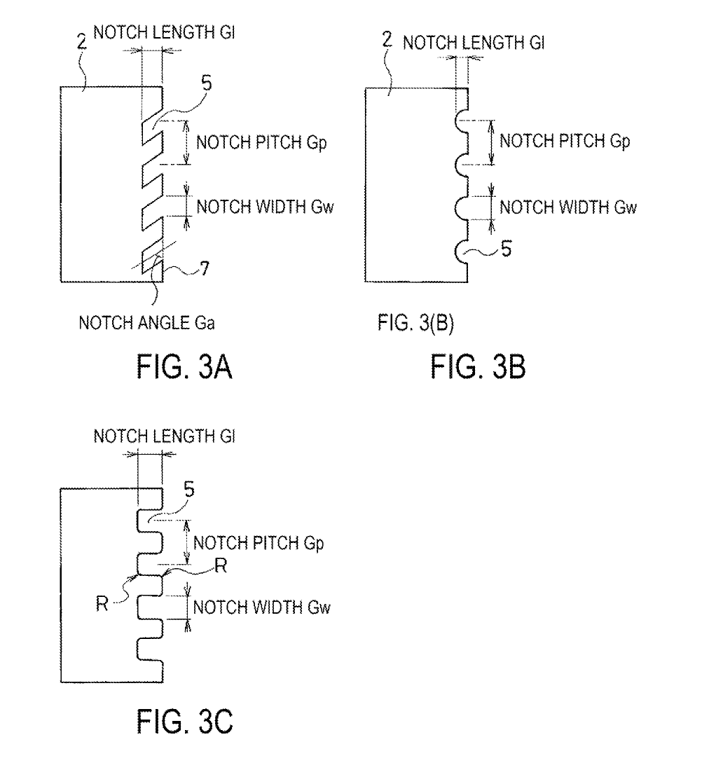

FIGS. 3A to 3C illustrate other examples of the shape of the notches 5 provided in the sheet 2. FIG. 3A is an example in which notches are provided in a parallelogram shape having a notch angle Ga of from 30° to 90° relative to the leading edge line 7 direction of the sheet 2 obtained from the thermoplastic resin or the thermoplastic resin composition of a thermoplastic resin blended with an elastomer. FIG. 3B illustrates an example of semicircular notches 5, and FIG. 3C illustrates an example in which the notches are of substantially the same rectangular shape as those illustrated in FIG. 1 but the corners are beveled (R).

In the present technology, the notch width Gw may be not greater than 80% of the notch pitch Gp.

The notches 5 are provided in the sheet 2 obtained from the thermoplastic resin or the thermoplastic resin composition of a thermoplastic resin blended with an elastomer arranged on the tire cavity side in the overlap splice portion S. They are positioned on the cavity side because that is where cracks and/or separation are readily generated and the effect of the present technology is great. However, they may also be provided in the sheet 2 on the tire outer circumferential side, or in both the top and bottom sheets 2.

Furthermore, the leading edge portion of the sheet 2 obtained from the thermoplastic resin or the thermoplastic resin composition of a thermoplastic resin blended with an elastomer that constitutes the overlap splice portion S has preferably been sharpened. This is more preferred because by sharpening the leading edge portion of the sheet 2, the end portion of the sheet 2 does not readily separate or curl.

As for the level of sharpening, the sharpening is preferably performed such that a thickness T (μm) at a position located inward by a distance of t×⅓ from the leading edge of the sheet obtained from the thermoplastic resin or the thermoplastic resin composition of a thermoplastic resin blended with an elastomer has a relationship that satisfies 0.1 t≦T≦0.8 t.

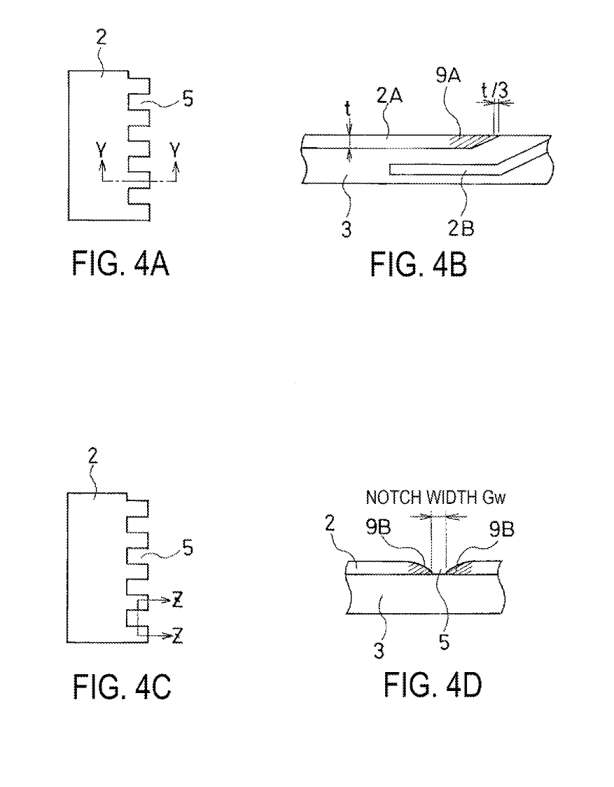

Here, t is the average thickness (μm) in the tire circumferential direction of a portion not subject to sharpening of the sheet obtained from the thermoplastic resin or the thermoplastic resin composition of a thermoplastic resin blended with an elastomer. T is the thickness (μm) of the sheet 2 at a position at a distance inward by a length of t×⅓ from the leading edge of the sheet obtained from the thermoplastic resin or the thermoplastic resin composition of a thermoplastic resin blended with an elastomer. This relationship is illustrated in FIGS. 4A and 4B. FIG. 4A is a plan view, and FIG. 4B is a section view in the circumferential direction thereof, which represents section Y-Y in the vicinity of the overlap splice portion shown in FIG. 4A. The leading edge of the sheet 2 has a sharpened portion 9A, indicated by diagonal lines.

Similar to sharpening at the end portion of such a sheet obtained from the thermoplastic resin or the thermoplastic resin composition of a thermoplastic resin blended with an elastomer, sharpening at both side wall portions of the notches 5 is effective in preventing generation of separation and the like, and is preferred in the present technology. It is preferred that both side wall portions of the notches be sharpened.

As for the level of sharpening, the sharpening is preferably performed such that a thickness T (μm) at a position located inward by a distance of t×⅓ in a direction perpendicular to the notch side walls from the leading edge of the notch side walls of the sheet obtained from the thermoplastic resin or the thermoplastic resin composition of a thermoplastic resin blended with an elastomer has a relationship that satisfies 0.1 t≦T≦0.8 t

Here, t is the average thickness (μm) in the tire circumferential direction of a portion not subject to sharpening of the sheet obtained from the thermoplastic resin or the thermoplastic resin composition of a thermoplastic resin blended with an elastomer. T is the thickness (μm) of the sheet 2 at a position at a distance inward by a length of t×⅓ in a direction perpendicular to the notch side walls from the leading edge of the sheet obtained from the thermoplastic resin or the thermoplastic resin composition of a thermoplastic resin blended with an elastomer.

This relationship is illustrated in FIGS. 4C and 4D. FIG. 4C is a plan view, and FIG. 4D is a section view in the radial direction (width direction) thereof, which represents section Z-Z in the vicinity of the overlap splice portion shown in FIG. 4C. Both side wall portions of the notch 5 have a sharpened portion 9B, indicated by diagonal lines.

The technique for forming such sharpened portions 9A and 9B is not particularly limited, but a sharpened shape of the leading edge may be formed by, for example, forming cuts or notches 5 while providing pressure so as to squash the sheet 2, using a blade, a laser cutter, or a heat cutter which has been brought to an appropriate temperature (normally not less than the glass transition temperature) as a cutter when cutting the sheet 2 or when forming the notches 5 in the sheet 2.

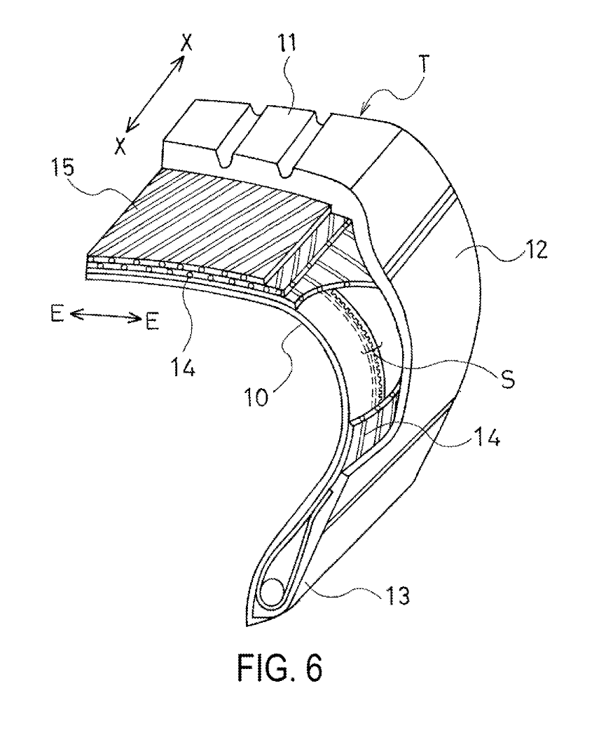

FIG. 6 is a partially fragmented perspective view illustrating an example of an aspect of the pneumatic tire according to the present technology. A pneumatic tire T is provided with a connected side wall portion 12 and bead portion 13 on the left and right of a tread portion 11. On the inner side of the tire, a carcass layer 14 that acts as a framework for the tire is provided so as to extend between the left and right bead portions 13, 13 in the tire width direction. Two belt layers 15 composed of steel cords are provided on the outer circumferential side of the carcass layer 14 corresponding to the tread portion 11. The arrow X indicates the tire circumferential direction, and the arrow E indicates the tire width direction. An inner liner layer 10 is disposed on an inner side of the carcass layer 14, and an overlap splice portion S thereof is present extending in the tire width direction. In the pneumatic tire according to the present technology, the generation of cracks and the occurrence of separation that conventionally often occur in the vicinity of the overlap splice portion S on the tire inner circumferential surface, and the generation of cracks between the tie rubber layer 3 and the sheet 2 obtained from the thermoplastic resin or the thermoplastic resin composition that form the inner liner layer 10 are suppressed and durability is noticeably improved.

While the overlap length L of the overlap splice portion S depends on tire size, the length is preferably around 7 to 20 mm, or more preferably around 8 to 15 mm. If the overlapping length is too large, uniformity tends to become worse, and if the overlapping length is too small, there is a risk that the splice portion may open during molding.

FIG. 6 is a typical example of the case in which the sheet obtained from the thermoplastic resin or the thermoplastic resin composition of a thermoplastic resin blended with an elastomer is used as the sheet that forms an inner liner layer of a pneumatic tire, but in addition to that, it may be used as a reinforcing sheet layer for reinforcing certain portions of a pneumatic tire.

When used as a reinforcing layer, the overlap splice portion S is present across the entire width of the tire, and notches may be provided across the entire width of that splice portion, but that is not necessarily required, and it is preferred that they extend in the tire width direction at least to “the region from the end portion of the belt layer that has the maximum belt width to the leading edge portion of the bead filler”. In particular, because deformation is large near the shoulder portions and near the sidewall portions during travel, cracks and/or separation readily occur in the vicinity of the splice portion, so preferably they are provided in the above-described region. It is particularly preferred that they be provided in a region that spans from the above-described region on one side to the above-described region on the opposite side (but excluding the bead portion), and, if desired and appropriate, they may be arranged only in that region, or in a center region (tread portion) sandwiched by the above-described regions, or in both of these regions.

When used as this reinforcing layer, it may be used in the case where it is disposed at a portion adjacent to a reinforcing layer such as the carcass layer or belt layer or another rubber layer inside the tire, or, it may be used in the bead portion or a tire surface portion (which is both the external surface and the cavity-side surface), such as the side portion or tread portion.

The thermoplastic resin to be used in the present technology is preferably a polyamide resin [e.g., nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 copolymer (N6/66/610), nylon MXD6 (MXD6), nylon 6T, nylon 9T, nylon 6/6T copolymer, nylon 66/PP copolymer, nylon 66/PPS copolymer] or an N-alkoxyalkyl compound thereof, e.g., a methoxymethyl compound of nylon 6, a methoxymethyl compound of a nylon 6/610 copolymer, or a methoxymethyl compound of nylon 612; a polyester resin [e.g., an aromatic polyester such as polybutylene terephthalate (PBT), polyethylene terephthalate (PET), polyethylene isophthalate (PEI), a PET/PEI copolymer, polyarylate (PAR), polybutylene naphthalate (PBN), a crystal polyester, a polyoxyalkylene diimide acid/polybutylene terephthalate copolymer]; a polynitrile resin [e.g., polyacrylonitrile (PAN), polymethacrylonitrile, an acrylonitrile/styrene copolymer (AS), a (meta) acrylonitrile/styrene copolymer, a (meta)acrylonitrile/styrene/butadiene copolymer], a polymethacrylate resin [e.g., polymethyl-methacrylate (PMMA), polyethyl-methacrylic acid], a polyvinyl resin [e.g., polyvinyl acetate, a polyvinyl alcohol (PVA), a vinyl alcohol/ethylene copolymer (EVOH), polyvinylidene chloride (PDVC), polyvinylchloride (PVC), a vinyl chloride/vinylidene chloride copolymer, a vinylidene chloride/methylacrylate copolymer, a vinylidene chloride/acrylonitrile copolymer], a cellulose resin [e.g., cellulose acetate, cellulose acetate butyrate], a fluoride resin [e.g., polyvinylidene difluoride (PVDF), polyvinyl fluoride (PVF), polychlorofluoroethylene (PCTFE), a tetrafluoroethylene/ethylene copolymer (ETFE)], or an imide resin [e.g., an aromatic polyimide (PI)].

Furthermore, in the thermoplastic resin and the elastomer that constitute the thermoplastic resin composition that can be used in the present technology, the above materials may be used as the thermoplastic resin. The elastomer to be used preferably includes a diene-based rubber and a hydrogenate thereof [e.g., natural rubber (NR), isoprene rubber (IR), epoxidized natural rubber, styrene butadiene rubber (SBR), butadiene rubber (BR, high cis-BR, low cis-BR), nitrile rubber (NBR), hydrogenated NBR, hydrogenated SBR], an olefin rubber [e.g., ethylene propylene rubber (EPDM, EPM), maleic acid ethylene propylene rubber (M-EPM), butyl rubber (IIR), an isobutylene and aromatic vinyl or diene-based monomer copolymer, acrylic rubber (ACM), an ionomer], a halogen-containing rubber [e.g., Br-IIR, CI-IIR, a brominated isobutylene-p-methylstyrene copolymer (BIMS), chloroprene rubber (CM), a hydrin rubber (CHR), chlorosulfonated polyethylene rubber (CSM), chlorinated polyethylene rubber (CM), chlorinated polyethylene rubber modified with maleic acid (M-CM)], a silicon rubber [e.g., methyl vinyl silicon rubber, dimethyl silicon rubber, methylphenyl vinyl silicon rubber], a sulfur-containing rubber [e.g., polysulfide rubber], a fluororubber [e.g., a vinylidene fluoride rubber, a vinyl ether rubber containing fluoride, a tetrafluoroethylene-propylene rubber, a silicon-based rubber containing fluoride, a phosphazene rubber containing fluoride], and a thermoplastic elastomer [e.g., a styrene elastomer, an olefin elastomer, an ester elastomer, a urethane elastomer, a polyamide elastomer].

Moreover, when the compatibility is different upon blending by combining the previously specified thermoplastic resin and the previously specified elastomer, a suitable compatibility agent may be used as a third component to enable compatibilization of both the resin and the elastomer. By mixing the compatibility agent in the blend, interfacial tension between the thermoplastic resin and the elastomer is reduced, and as a result, the particle diameter of the elastomer that forms the dispersion phase becomes very small and thus the characteristics of both components may be realized effectively. In general, such a compatibility agent has a copolymer structure of at least one of the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. While the type of compatibility agent may be selected according to the type of thermoplastic resin and elastomer to be blended, such a compatibility agent generally includes: a styrene/ethylene butylene block copolymer (SEBS) or a maleic acid modified compound thereof; a EPDM, EPM, EPDM/styrene or EPDM/acrylonitrile graft copolymer or a maleic acid modified compound thereof; a styrene/maleic acid copolymer, or a reactive phenoxy, and the like. The blending quantity of such a compatibility agent, while not being limited, is preferably 0.5 to 10 parts by weight with respect to 100 parts by weight of the polymer component (total of the thermoplastic resin and the elastomer).

A composition ratio of the specific thermoplastic resin and the elastomer in the thermoplastic resin composition of a thermoplastic resin blended with an elastomer, while not limited in particular, may be determined as appropriate to establish a dispersed structure as a discontinuous phase of the elastomer in the matrix of the thermoplastic resin, and is preferably a range of a weight ratio of 90/10 to 30/70.

In the present technology, a compatibility agent or other polymer within a range that does not harm the characteristics required for an inner liner or a reinforcing member may be blended with the thermoplastic resin or the thermoplastic resin composition of a thermoplastic resin blended with an elastomer.

The purposes of mixing such a polymer are to improve the compatibility between the thermoplastic resin and the elastomer, to improve the molding processability of the material, to improve the heat resistance, to reduce cost, and so on. Examples of the material used for the polymer include polyethylene (PE), polypropylene (PP), polystyrene (PS), ABS, SBS, and polycarbonate (PC). Furthermore, a reinforcing agent such as a filler (calcium carbonate, titanium oxide, alumina, and the like), carbon black, or white carbon, a softening agent, a plasticizer, a processing aid, a pigment, a dye, an anti-aging agent, or the like generally compounded with polymer compounds may be optionally compounded so long as the characteristics required for an inner liner or reinforcing member are not harmed. The thermoplastic resin composition has a structure in which the elastomer is distributed as a discontinuous phase in the matrix of the thermoplastic resin. By having such a structure, it becomes possible to provide the inner liner or the reinforcing member with sufficient flexibility and sufficient rigidity that is attributed to the effect of the resin layer as a continuous phase. Furthermore, it becomes possible to obtain, during molding, a molding workability equivalent to that of the thermoplastic resin regardless of the amount of the elastomer.

Furthermore, the elastomer can be dynamically vulcanized when being mixed in with the thermoplastic resin. A vulcanizer, a vulcanization assistant, vulcanization conditions (temperature, time), and the like, during the dynamic vulcanization can be determined as appropriate in accordance with the composition of the elastomer to be added, and are not particularly limited.

When the elastomer in the thermoplastic resin composition is dynamically vulcanized in this manner, the obtained resin sheet becomes a sheet that includes a vulcanized elastomer; therefore, this sheet is preferable in that it has resistance (elasticity) against deformation from the outside, and in particular, it easily maintains the structure of the notch-shaped notch edge lines, and it can reliably obtain the effects of the present technology.

Generally available rubber vulcanizers (crosslinking agents) can be used as the vulcanization agent. Specifically, as a sulfur-based vulcanizer, powdered sulfur, precipitated sulfur, highly dispersible sulfur, surface treated sulfur, insoluble sulfur, dimorpholine disulfide, alkylphenol disulfide, and the like can be illustrated, and, for example, approximately 0.5 to 4 phr (in the present specification, “phr” refers to parts by weight per 100 parts per weight of an elastomer component; same below) can be used.

Moreover, examples of an organic peroxide-based vulcanizer include benzoyl peroxide, t-butyl hydroperoxide, 2,4-dichlorobenzoyl peroxide, 2,5-dimethyl-2,5-di(t-butyl peroxy)hexane, and 2,5-dimethylhexane-2,5-di(peroxyl benzoate). Such an organic peroxide-based vulcanizer can be used in an amount of, for example, approximately 1 to 20 phr.

Furthermore, examples of a phenol resin-based vulcanizer includes brominated alkylphenol resins and mixed crosslinking system containing an alkyl phenol resin with a halogen donor such as tin chloride and chloroprene. Such a phenol resin-based vulcanizer can be used in an amount of, for example, approximately 1 to 20 phr.

Examples of other vulcanizers include zinc white (approximately 5 phr), magnesium oxide (approximately 4 phr), litharge (approximately 10 to 20 phr), p-quinone dioxime, p-dibenzoylquinone dioxime, tetrachloro-p-benzoquinone, poly-p-dinitrosobenzene (approximately 2 to 10 phr), and methylenedianiline (approximately 0.2 to 10 phr).

As necessary, a vulcanization accelerator may be added. As the vulcanization accelerator, approximately 0.5 to 2 phr, for example, of a generally available vulcanization accelerator of an aldehyde-ammonia base, a guanidine base, a thiazole base, a sulfenamide base, a thiuram base, a dithio acid salt base, a thiourea base, or the like can be used.

Specific examples include an aldehyde ammonia vulcanization accelerator such as hexamethylene tetramine and the like; a guanidine vulcanization accelerator such as diphenyl guanidine and the like; a thiazole vulcanization accelerator such as dibenzothiazyl disulfide (DM), 2-mercaptobenzothiazole and its Zn salt; a cyclohexylamine salt, and the like; a sulfenamide vulcanization accelerator such as cyclohexyl benzothiazyl sulfenamide (CBS), N-oxydiethylene benzothiazyl-2-sulfenamide, N-t-butyl-2-benzothiazole sulfenamide, 2-(thymol polynyl dithio)benzothizole, and the like; a thiuram vulcanization accelerator such as tetramethylthiuram disulfide (TMTD), tetraethylthiuram disulfide, tetramethylthiuram monosulfide (TMTM), dipentamethylenethiuram tetrasulfide, and the like; a dithionate vulcanization accelerator such as Zn-dimethyl dithiocarbamate, Zn-diethyl dithiocarbamate, Zn-n-butyl dithiocarbamate, Zn-ethylphenyl dithiocarbamate, Te-diethyl dithiocarbamate, Cu-dimethyl dithiocarbamate, Fe-dimethyl dithiocarbamate, pipecoline pipecolyl dithiocarbamate, and the like; and a thiourea vulcanization accelerator such as ethylene thiourea, diethyl thiourea, and the like may be mentioned. Additionally, a vulcanization accelerator assistant which is generally-used for a rubber can be used. For example, zinc white (approximately 5 phr), stearic acid, oleic acid and their Zn salts (approximately 2 to 4 phr), or the like can be used.

The method for producing the thermoplastic resin composition is as follows. The thermoplastic resin and the elastomer (unvulcanized in the case of rubber) are melt-kneaded in advance by a twin-screw kneader extruder or the like. The elastomer is dispersed as a dispersion phase (domain) in the thermoplastic resin forming a continuous phase (matrix). When the elastomer is vulcanized, the vulcanizer can be added during the kneading process to dynamically vulcanize the elastomer. Although the various compounding agents (except for vulcanizer) may be added to the thermoplastic resin or the elastomer during the kneading process, it is preferable to premix the compounding agents before the kneading process. The kneader used for kneading the thermoplastic resin and the elastomer is not particularly limited. A screw extruder, kneader, Banbury Mixer, bi-axial kneader/extruder, or the like can be used as the kneader. Among these, a bi-axial kneader/extruder is preferably used for kneading the thermoplastic resin and the elastomer and for dynamically vulcanizing the elastomer. Furthermore, two or more types of kneaders can be used to successively knead the thermoplastic resin and the elastomer component. As a condition for the melt kneading, a temperature should equal to or higher than a melting temperature of the thermoplastic resin. Furthermore, a maximum shearing speed during the kneading process is preferably from 300 to 7,500 sec⁻¹. A total kneading time is from 30 seconds to 10 minutes. Additionally, when a vulcanizing agent is added, a vulcanization time after this addition is preferably from 15 seconds to 5 minutes. The polymer composition produced by the above method may be formed into a desired shape by a generally-used method for forming a thermoplastic resin such as injection molding and extrusion molding.

The thermoplastic resin composition thus obtained has a structure in which the elastomer is dispersed as a discontinuous phase in the matrix of the thermoplastic resin. By having such a structure, sufficient flexibility and the effect of the resin layer as a continuous phase allow both sufficient air permeation prevention for an inner liner or reinforcing layer and strength to be imparted, and also, during molding, independent of the amount of the elastomer, molding workability equal to that of the thermoplastic resin can be obtained.

The Young's moduli of the thermoplastic resin and the thermoplastic resin composition are not particularly limited, but are preferably set to 1 to 500 MPa, and more preferably 25 to 250 MPa.

### Examples

The pneumatic tire of the present technology will be specifically described below by working examples and the like.

In the working examples and comparative examples below, compulsory testing was conducted in all cases after overlap splicing of the laminate sheet according to the present technology in formation of an inner liner layer.

Furthermore, the “number of cracks” and “total crack length” of the pneumatic tires were evaluated while comparing the generation of cracks and the generation of separation in the vicinity of the splice portion of the inner liner layer of the cavity of the test tires with the situation in other portions thereof.

As test tires, two tires, 215/70R15 98H, were produced for each working example and comparative example. The tires were installed on JATMA (Japan Automobile Tire Manufacturers Association) standard rims 15×6.5 JJ, and with the tire internal pressure set to the JATMA maximum air pressure (240 kPa), they traveled for 50,000 km at a velocity of 80 km/hour.

At that time, the load was 8.82 kN, which is equivalent to 120% of the JATMA maximum load. This test is a compulsory accelerated test in which standards and conditions are harsher than the level of normal use.

As the sheet 2 obtained from the thermoplastic resin or the thermoplastic resin composition that constitutes the inner liner layer, in Comparative Examples 1 and 2, Working Examples 1 to 6, and Working Examples 7 to 12, sheets 150 μm thick of a thermoplastic resin composition in which N6/66 as the thermoplastic resin and BIMS as the elastomer were blended in a 50/50 ratio were prepared as shown in Table 1.

TABLE 1

| | | Parts by |
|---|---|---|
| | | mass |
| BIMS^{a)} | “Exxpro 3035” made by ExxonMobile | 100 |
| | Chemical Co. | |
| Zinc oxide | “Zinc white type III” made by Seido Chemical | 0.5 |
| | Industry Co., Ltd. | |
| Stearic acid | Industrial stearic acid | 0.2 |
| Zinc stearate | “Zinc stearate” made by NOF Corporation | 1 |
| N6/66 | “UBENYLON B5033B” made by Ube | 100 |
| | Industries, Ltd. | |
| Modified | “HPR-AR201” made by Dupont-Mitsui | 10 |
| EEA^{b)} | Polychemicals Co., Ltd. | |

Notes:
^{a)}Brominated isobutylene-p-methylstyrene copolymer
^{b)}Maleic anhydride-modified ethylene-ethyl acrylate copolymer

The composition of the adhesive rubber was as shown in Table 2 in all examples.

TABLE 2

| | | Parts |
|---|---|---|
| | | by |
| | | mass |
| Styrene | “Nipol1502” made by Zeon Corporation | 50 |
| butadiene rubber | | |
| Natural rubber | SIR-20 | 50 |
| Carbon black | “SEAST V” made by Tokai Carbon Co., Ltd. | 60 |
| Stearic acid | Industrial stearic acid | 1 |
| Aromatic oil | “Desolex #3” made by Showa Shell | 7 |
| | Sekiyu KK | |
| Zinc oxide | “Zinc White No. 3” made by Seido | 3 |
| | Chemical Industry Co., Ltd. | |
| Modified | “Sumikanol 620” made by Taoka | 2 |
| resorcin | Chemical Co., Ltd. | |
| formaldehyde | | |
| condensate | | |
| Methylene donor | Modified ether methylolmelamine | 6 |
| | “Sumikanol 507AP” made by Taoka | |
| | Chemical Co., Ltd. | |
| Sulfur | 5% oil-extension treated sulfur | 6 |
| Vulcanization | Di-2-benzothiazolyl disulfide “NOCCELLER | 2.2 |
| accelerator | DM” made by Ouchi Shinko Chemical | |
| | Industrial Co., Ltd. | |

### Working Examples 1 to 6, Comparative Example 1

The shapes and dimensions of the notches and the evaluation results and the like were as shown in Table 3. In Working Examples 1 to 6 and Comparative Example 1, the overlap length of the overlap splice portion was 10 mm in all cases. The shape of the notches was as shown in FIG. 2A in all cases, but all corners were beveled (R) with a radius of 1 m as shown in FIG. 3C. The total of widths of non-notch portions on the sheet end portion were 50% of the total width of the sheet (Working Example 1, Working Examples 4 to 6), 16.7% (Working Example 2), and 20% (Working Example 3), as determined from the values of notch width (mm) and notch pitch (mm) shown in Table 3.

As is understood from these results, according to the present technology, a pneumatic tire with excellent durability in which crack generation is suppressed can be obtained.

TABLE 3

| | Comparative | Working | Working | Working | Working | Working | Working |
|---|---|---|---|---|---|---|---|
| | Example 1 | Example 1 | Example 2 | Example 3 | Example 4 | Example 5 | Example 6 |
| Splice structure | FIG. 1C | FIG. 1C | FIG. 1C | FIG. 1C | FIG. 1C | FIG. 1C | FIG. 1C |
| Notch shape | None | FIG. 2A | FIG. 2A | FIG. 2A | FIG. 2A | FIG. 2A | FIG. 2A |
| Notch location | — | Cavity side | Outer circumferential | Cavity side | Cavity side | Cavity side | Cavity side |
| | | only | side only | only | only | only | only |
| Notch pitch (mm) | — | 2 mm | 6 mm | 30 mm | 30 mm | 30 mm | 30 mm |
| Notch length (mm) | — | 10 mm | 10 mm | 10 mm | 2 mm | 15 mm | 4 mm |
| Notch angle (degrees) | — | 90 degrees | 90 degrees | 90 degrees | 90 degrees | 90 degrees | 90 degrees |
| Notch width (mm) | — | 1 mm | 5 mm | 24 mm | 15 mm | 15 mm | 15 mm |
| Sharpening of end portion | — | No | No | No | No | No | No |
| Number of cracks | 2 | 16 | 6 | 4 | 4 | 4 | 4 |
| (maximum length) | (75 mm) | (2 mm) | (12 mm) | (15 mm) | (15 mm) | (12 mm) | (15 mm) |
| Crack total length (mm) | 152 mm | 32 mm | 70 mm | 55 mm | 60 mm | 47 mm | 56 mm |

### Working Examples 7 to 12, Comparative Example 2

The shapes and dimensions of the notches and the evaluation results and the like were as shown in Table 4. In Working Examples 1 to 6 and Comparative Example 1, the overlap length L of the overlap splice portion was 10 mm in all cases. The shape of the notches was as shown in FIG. 2A in all cases, but all corners were beveled (R) with a radius of 1 m as shown in FIG. 3C. The total of widths of non-notch portions on the sheet end portion were 50% of the total width of the sheet in all cases (Working Examples 7 to 12), as determined from the values of notch width (mm) and notch pitch (mm) shown in Table 4.

As is understood from these results, according to the present technology, a pneumatic tire with excellent durability in which crack generation is suppressed can be obtained.

TABLE 4

| | Comparative | Working | Working | Working | Working | Working | Working |
|---|---|---|---|---|---|---|---|
| | Example 2 | Example 7 | Example 8 | Example 9 | Example 10 | Example 11 | Example 12 |
| Splice structure | FIG. 1B | FIG. 1B | FIG. 1B | FIG. 1B | FIG. 1B | FIG. 1B | FIG. 1B |
| Notch shape | None | FIG. 2A | FIG. 2A | FIG. 2A | FIG. 2A | FIG. 2A | FIG. 2A |
| Notch location | — | Cavity side | Outer | Cavity side | Cavity side | Cavity side | Cavity side |
| | | only | circumferential | only | only | only | only |
| | | | side only | | | | |
| Notch pitch (mm) | — | 30 mm | 30 mm | 30 mm | 30 mm | 30 mm | 30 mm |
| Notch length (mm) | — | 10 mm | 10 mm | 10 mm | 10 mm | 10 mm | 10 mm |
| Notch angle (degrees) | | 90 degrees | 90 degrees | 90 degrees | 90 degrees | 90 degrees | 90 degrees |
| Notch width (mm) | — | 15 mm | 15 mm | 15 mm | 15 mm | 15 mm | 15 mm |
| Sharpening of end | — | No | No | No | No | Leading | Both side |
| portion | | | | | | edge only | wall portions |
| Number of cracks | 2 | 4 | 4 | 4 | 2 | 0 | 2 |
| (maximum length) | (80 mm) | (15 mm) | (20 mm) | (15 mm) | (15 mm) | (—) | (8 mm) |
| Crack total length | 155 mm | 60 mm | 79 mm | 60 mm | 30 mm | 0 mm | 15 mm |
| (mm) | | | | | | | |

1. A pneumatic tire comprising:
an overlap splice portion formed by laminating a sheet obtained from a thermoplastic resin or a thermoplastic resin composition of a thermoplastic resin blended with an elastomer above and below an interposed rubber layer that undergoes vulcanizing adhesion with the thermoplastic resin or the thermoplastic resin composition, wherein the sheet obtained from the thermoplastic resin or the thermoplastic resin composition of a thermoplastic resin blended with an elastomer that is employed has a plurality of notches having a notch width greater than 1.0 mm provided in a leading edge portion or a vicinity of the leading edge portion of at least one side of the sheet.

2. The pneumatic tire according to claim 1, wherein a total of widths of non-notch portions of a sheet end portion, in which the notches are provided, of the sheet obtained from the thermoplastic resin or the thermoplastic resin composition of a thermoplastic resin blended with an elastomer is from 20% to 50% of a total width of the sheet.

3. The pneumatic tire according to claim 1, wherein the notches are provided having a notch pitch of not less than 2 mm and not greater than 30 mm.

4. The pneumatic tire according to claim 1, wherein the length of the notches, as the length of the tire circumferential direction component thereof, is not less than 0.2 times and not greater than 1.5 times the overlap length of the overlap splice portion.

5. The pneumatic tire according to claim 4, wherein the length of the notches, as the length of the tire circumferential direction component thereof, is not less than 0.4 times and not greater than 1.0 times the overlap length of the overlap splice portion.

6. The pneumatic tire according to claim 1, wherein the notches are provided having a notch angle of from 30° to 90° relative to a leading edge portion line direction of the sheet obtained from the thermoplastic resin or the thermoplastic resin composition of a thermoplastic resin blended with an elastomer.

7. The pneumatic tire according to claim 1, wherein the width of the notches is not greater than 80% of the notch pitch.

8. The pneumatic tire according to claim 1, wherein the notches are provided in the sheet obtained from the thermoplastic resin or the thermoplastic resin composition of a thermoplastic resin blended with an elastomer arranged on a tire cavity side in the overlap splice portion.

9. The pneumatic tire according to claim 1, wherein the leading edge portion of the sheet obtained from the thermoplastic resin or the thermoplastic resin composition of a thermoplastic resin blended with an elastomer in the overlap splice portion is sharpened.

10. The pneumatic tire according to claim 9, wherein the sharpening has a relationship in which a thickness T (μm) at a position at a distance inward by a length of t×⅓ from the leading edge of the sheet obtained from the thermoplastic resin or the thermoplastic resin composition of a thermoplastic resin blended with an elastomer satisfies the equation 0.1 t≦T≦0.8 t;
wherein t is the average thickness (μm) in the tire circumferential direction of a portion not subject to sharpening of the sheet obtained from the thermoplastic resin or the thermoplastic resin composition of a thermoplastic resin blended with an elastomer, and
T is the thickness (μm) of the sheet 2 at a position at a distance inward by a length of t×⅓ from the leading edge of the sheet obtained from the thermoplastic resin or the thermoplastic resin composition of a thermoplastic resin blended with an elastomer.

11. The pneumatic tire according to claim 1, wherein both side wall portions of the notches are sharpened.

12. The pneumatic tire according to claim 11, wherein the sharpening of both side wall portions of the notches has a relationship in which a thickness T (μm) at a position at a distance inward by a length of t×⅓ in a direction perpendicular to the notch side walls from the leading edge of the notch side walls of the sheet obtained from the thermoplastic resin or the thermoplastic resin composition of a thermoplastic resin blended with an elastomer satisfies the equation 0.1 t≦T≦0.8 t;
wherein t is the average thickness (μm) in the tire circumferential direction of a portion not subject to sharpening of the sheet obtained from the thermoplastic resin or the thermoplastic resin composition of a thermoplastic resin blended with an elastomer, and
T is the thickness (μm) of the sheet 2 at a position at a distance inward by a length of t×⅓ in a direction perpendicular to the notch side walls from the leading edge of the notch side walls of the sheet obtained from the thermoplastic resin or the thermoplastic resin composition of a thermoplastic resin blended with an elastomer.

13. The pneumatic tire according to claim 2, wherein the notches are provided having a notch pitch of not less than 2 mm and not greater than 30 mm.

14. The pneumatic tire according to claim 13, wherein the length of the notches, as the length of the tire circumferential direction component thereof, is not less than 0.2 times and not greater than 1.5 times the overlap length of the overlap splice portion.

15. The pneumatic tire according to claim 14, wherein the length of the notches, as the length of the tire circumferential direction component thereof, is not less than 0.4 times and not greater than 1.0 times the overlap length of the overlap splice portion.

16. The pneumatic tire according to claim 15, wherein the notches are provided having a notch angle of from 30° to 90° relative to a leading edge portion line direction of the sheet obtained from the thermoplastic resin or the thermoplastic resin composition of a thermoplastic resin blended with an elastomer.

17. The pneumatic tire according to claim 16, wherein the width of the notches is not greater than 80% of the notch pitch.

18. The pneumatic tire according to claim 17, wherein the notches are provided in the sheet obtained from the thermoplastic resin or the thermoplastic resin composition of a thermoplastic resin blended with an elastomer arranged on a tire cavity side in the overlap splice portion.

19. The pneumatic tire according to claim 18, wherein the leading edge portion of the sheet obtained from the thermoplastic resin or the thermoplastic resin composition of a thermoplastic resin blended with an elastomer in the overlap splice portion is sharpened.

20. The pneumatic tire according to claim 19, wherein the sharpening has a relationship in which a thickness T (μm) at a position at a distance inward by a length of t×⅓ from the leading edge of the sheet obtained from the thermoplastic resin or the thermoplastic resin composition of a thermoplastic resin blended with an elastomer satisfies the equation 0.1 t≦T≦0.8 t;
wherein t is the average thickness (μm) in the tire circumferential direction of a portion not subject to sharpening of the sheet obtained from the thermoplastic resin or the thermoplastic resin composition of a thermoplastic resin blended with an elastomer, and
T is the thickness (μm) of the sheet 2 at a position at a distance inward by a length of t×⅓ from the leading edge of the sheet obtained from the thermoplastic resin or the thermoplastic resin composition of a thermoplastic resin blended with an elastomer.
